(19) United States
(12) Patent Application Publication
(10) Pub. No.: US 2012/0103186 A1
(43) Pub. Date: May 3, 2012

(54) Method For Adjusting The Purity Of Oxygen Generated By An Adsorption Unit By Controlling The Flow Rate

(75) Inventors: Joseph Pierquin, Molsheim (FR); Sylvain Fourage, Issy les Moulineaux (FR); Olivier Roy, Bourges (FR)

(73) Assignee: L'Air Liquide Societe Anonyme Pour L'Ftude Et L'Exploitation Des Procedes Georges Claude, Paris (FR)

(21) Appl. No.: 13/378,062

(22) PCT Filed: Jun. 7, 2010
(86) PCT No.: PCT/FR2010/051116

§ 371 Date: Dec. 14, 2011

(30) Foreign Application Priority Data
Jun. 15, 2009 (FR) 0953965

(51) Int. Cl. B01D 53/047; B01D 53/30

(52) U.S. Cl. 95/11; 95/12

(57) ABSTRACT

The invention relates to a method for producing gaseous oxygen by adsorption from compressed air, comprising: a) using at least one adsorption unit for generating gaseous oxygen having a purity greater than or equal to a predetermined purity threshold value (VPS) and according to a variable production flow rate (Dp); b) recovering the gaseous oxygen produced in a); c) measuring the purity of the gaseous oxygen (Pp) produced in step a) and comparing same with a preset purity threshold value (VPS); and d) adjusting the oxygen production flow rate (Dp) on the basis of the comparison of step c) such that: i) reducing the oxygen production flow rate (Dp) when the oxygen purity (Pp) measured in step c) is such that VPS>Pp; or ii) increasing the production flow rate (Dp) when the oxygen purity determined in step c) is such that VPS<Pp in order to obtain a gaseous oxygen purity (Pp) such that VPS=Pp+X, with X<0.5%, X being the standard deviation.

The present invention relates to a method for regulating a method or a unit for gas separation by adsorption, in particular a method or unit of the VSA type, producing an oxygen-rich gas from ambient air.

The possibility of controlling the purity of the oxygen-rich gas produced at the output of a unit for gas separation by adsorption, in particular a unit of the VSA type, has already been studied, particularly in documents U.S. Pat. No. 5,258,056.

The difficulty of controlling this oxygen purity resides in the selection of the action variables, given that there are many possibilities for controlling this purity: acting on the cycle times, the pressures in the adsorbers, the flow rates and/or pressures of the unit, etc.

In view of these difficulties, VSA methods for producing oxygen, commonly referred to as “O₂ VSA methods”, are currently controlled by simple control loops for pressure or flow rate at the compression output and/or maximum pressure in the adsorbers.

This absence of precise control often leads to a loss of productivity, which makes it necessary to provide an additional supply of liquid oxygen (LOX) for the user, when the production of the O₂ VSA is insufficient to guarantee this user a minimum purity and/or oxygen flow rate for its application, for example to manufacture glass, paper pulp, to supply aquaculture or the like. This additional supply of liquid oxygen for the user in turn generates a significant extra cost.

Document U.S. Pat. No. 5,258,056 teaches a PSA method for producing nitrogen from atmospheric air, in which the oxygen is an impurity to be eliminated. The level of impurities, i.e. oxygen, is used to control the supply of air entering the PSA system.

Document U.S. Pat. No. 4,725,293 moreover describes a similar PSA method also making it possible to produce nitrogen from ambient air.

The problem which then arises is to be able to minimize the provision of liquid oxygen by carrying out effective control of the VSA method and/or unit so as to improve its productivity.

A solution of the invention is a method for producing gaseous oxygen from compressed air by adsorption, in which:
a) gaseous oxygen having a purity greater than or equal to a given purity threshold value (VPS) is produced with a variable production flow rate (Dp) by means of at least one adsorption unit,
b) the gaseous oxygen produced in a) is recovered and is conveyed by means of at least one gas pipeline to a user site or storage site,
c) the purity of gaseous oxygen (Pp) produced in step b) and carried by said gas pipeline is measured before the user site or storage site and compared with the preset purity threshold value (VPS), and
d) the oxygen production flow rate (Dp) is adjusted before the user site or storage site as a function of the comparison carried out in step c) so that:
   i) the oxygen production flow rate (Dp) is reduced when the oxygen purity (Pp) measured in step c) is such that: VPS>Pp or
   ii) the production flow rate (Dp) is increased when the oxygen purity (Pp) determined in step c) is such that: VPS<Pp so as to obtain a gaseous oxygen purity (Pp) such that:

VPS=Pp+X with X<0.5%. X being the standard deviation,
e) the produced oxygen is sent at a production flow rate (Dp) to a user site, and
f) when the user flow rate (Du) is such that Du>Dp, oxygen coming from a source of liquid oxygen (LOX) is added to the gas pipeline, the liquid oxygen being vaporized before its introduction into the gas pipeline, so as to obtain a given user oxygen purity (Pu) such that: VPS=Pu+X
where:
   the oxygen purity (Pu) is measured on the pipeline downstream of the injection site of liquid oxygen (LOX)
   the user flow rate (Du) is the flow rate of oxygen consumed by the user site.

Depending on the case, the method according to the invention may have one or more of the following characteristics:
the oxygen production flow rate is adjusted in step d) so that VPS=Pp+X with X<0.3%, preferably X<0.2%, more preferably X<0.1%;
the recovered gaseous oxygen is compressed in step b) before it is conveyed to the user site by means of the gas pipeline;
the gaseous oxygen is produced in step a) by an adsorption unit of the VSA or PSA type;
the purity threshold value (VPS) is at least 70% by volume, preferably between 85 and 95%, advantageously from 90% to 93%;
the oxygen is produced in step a) by separation of air by adsorption of nitrogen on at least one adsorbent which adsorbs nitrogen preferentially to oxygen, the adsorbent preferably being a zeolite;
the oxygen production flow rate is adjusted in step d) by acting on the opening of a recirculation valve situated on a bypass line formed on the gas pipeline carrying the produced oxygen, said bypass line making it possible to bypass at least one gas compressor situated on said gas pipeline, downstream of the adsorption unit, and furthermore serving to recycle, upstream of said at least one compressor, oxygen collected downstream of said compressor;
the production flow rate (Dp) is between 100 and 6000 Nm³/h;
the user flow rate (Du) is between 100 and 10 000 Nm³/h;
the purity (Pp) of the oxygen is between 88 and 95%; and
the user oxygen purity (Pu) is between 88 and 100%.

The solution of the invention is therefore based on installing a loop for regulating the purity to a purity threshold value (VPS) on the O₂ VSA unit, the loop being intended to adjust the flow rate of oxygen produced (Dp) in real time so as to reduce the required quantity of liquid oxygen, referred to as “LOX”.

Specifically, according to the current operating mode, a flow rate limit of the VSA unit is set so that O₂ purity (Pp) in the oxygen-enriched gas produced by the VSA unit is always greater than the set threshold value (VPS) set by the client, for example at a purity of 90% by volume.

However, this leads to O₂ purity values (Pp) very much greater than the desired purity threshold value (VPS), which may reach for example 92% in certain cases.

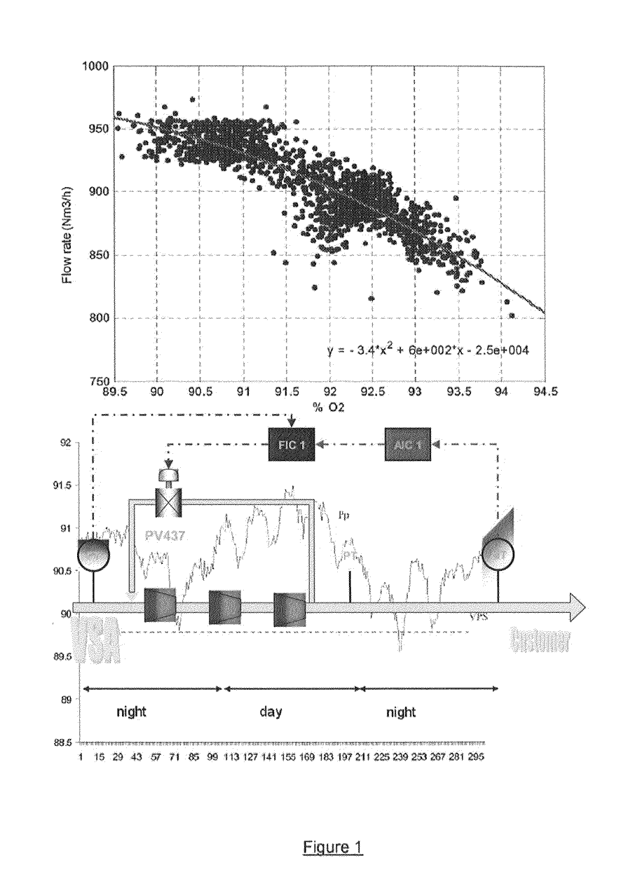

This phenomenon is due in particular to climatic variations, such as day/night and summer/winter temperature differences, as can be seen in FIG. 1.

The principle of the control loop of the invention consists in adjusting this flow rate (Dp) in real time in order to ensure a purity of oxygen produced (Pp) equal to VPS or differing very little from VPS (standard deviation 0.1%) and therefore to avoid or minimize the use of LOX.

This type of regulation therefore makes it possible to economize on LOX by optimizing the productivity of the VSA, to obtain a reduction in the number of procedures of the “purity search” type by adapting the flow rate of the VSA to the decrease in flow rate so as not to “lose” the O₂ purity, and leads to a reduction in the user interventions for modifying the regulation of the oxygen production flow rate (Dp).

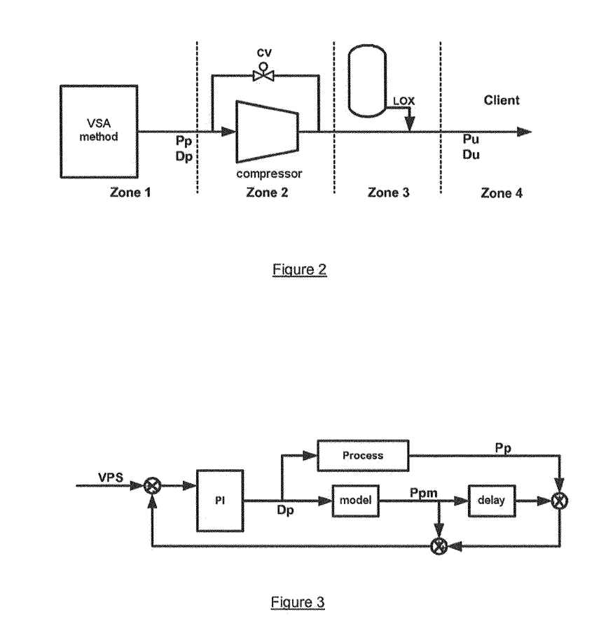

FIG. 2 schematizes the operating principle of a method according to the invention, applied to an adsorption unit 1 of the O2 VSA type producing oxygen whose purity has to be kept permanently at least at 90% by volume, which constitutes the desired purity threshold value (VPS).

The oxygen produced is recovered at the output of the O2 VSA (zone 1) and conveyed to a container (not shown) as far as a client site (zone 4) by means of at least one compressor (zone 2) by means of a pipeline.

In order to control the oxygen flow rate, the recirculation valve Qr is driven according to a flow rate control loop or “loop FIC 1”. The function of the latter is to limit the production flow rate (Dp) of the unit to the value set by the operator, irrespective of the client demand (Du).

The regulation principle of the invention therefore consists in adapting the reference of the loop FIC 1 as a function of the oxygen purity measurement (Pp).

In other words, the principle of the control loop consists in adapting the production flow rate limit (Dp) in real time in order to ensure a purity at the capacity limits of the VSA unit. This adaptation is obtained by virtue of the functional diagram given in FIG. 3 and employing a so-called “predictive” or “Smith predictor” regulation algorithm.

The advantage of this type of regulation is that it “predicts” the O2 purity (Pp) by virtue of a model giving a modeled purity (Ppm), and thus allowing regulation by anticipation.

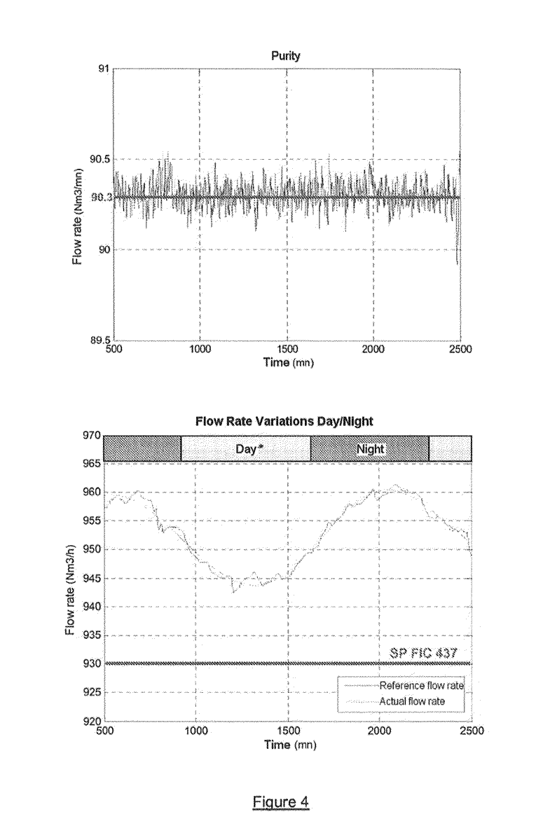

Installing this regulation system then makes it possible to have a distribution of the purity around the VPS with a standard deviation difference less than 0.5%, typically of the order of 0.1%, as shown by the curves of FIG. 4, independently of the day/night cycles.

However, as illustrated in FIG. 2, when the user flow rate (Du) becomes greater than the production flow rate (Dp), this oxygen demand is compensated for by introducing backup oxygen coming from a source of liquid oxygen (LOX), which is connected to the pipeline carrying the gaseous oxygen from the VSA to the user site. The LOX is vaporized beforehand prior to its injection into the pipeline (zone 3). A working oxygen purity value (Pu) is thus obtained such that VPS=Pu+X where Pu is the O2 purity measured downstream of the site of introduction of the LOX into the pipeline.

This injection of backup LOX is particularly advantageous because it makes it possible to cater for peaks in oxygen demand from the user site.

1-9. (canceled)

10. A method for producing gaseous oxygen from compressed air by adsorption, the method comprising the steps of:
a) producing a gaseous oxygen by flowing the compressed air through at least one adsorption unit with a variable production flow rate (Dp), measuring a first purity of the gaseous oxygen and verifying a purity greater than or equal to a predetermined purity threshold value (VPS)
b) recovering the gaseous oxygen produced in step a) and conveying the gaseous oxygen through at least one gas pipeline to a user site or storage site,
c) measuring a second purity of the gaseous oxygen (Pp) produced in step a) and carried by said gas pipeline before the gaseous oxygen reaches the user site or storage site and comparing the second purity with the predetermined purity threshold value (VPS),
d) adjusting an oxygen production flow rate (Dp) before the user site or storage site as a function of the comparison carried out in step c) so that:
i) the oxygen production flow rate (Dp) is reduced when the oxygen purity (Pp) measured in step c) is such that: VPS>Pp or
ii) the production flow rate (Dp) is increased when the oxygen purity (Pp) determined in step c) is such that: VPS<Pp
so as to obtain a gaseous oxygen purity (Pp) such that:
VPS=Pp+X with X being the standard deviation and X<0.5%.
e) sending the produced oxygen at a production flow rate (Dp) to a user site, and
f) adding oxygen coming from a source of liquid oxygen (LOX) to the gas pipeline when a rate of oxygen consumed by the user site (Du) is such that Du>Dp, the liquid oxygen being vaporized before its introduction into the gas pipeline, so as to obtain a given user oxygen purity (Pu) such that: VPS=Pu+X
where:
the oxygen purity (Pu) is measured on the pipeline downstream of the injection site of liquid oxygen (LOX).

11. The method as claimed in claim 10, wherein the oxygen production flow rate is adjusted in step d) so that VPS=Pp+X with X<0.3%.

12. The method of claim 10, wherein the oxygen production flow rate is adjusted in step d) so that VPS=Pp+X with X<0.1%.

13. The method of claim 10 wherein the recovered gaseous oxygen is compressed in step b) before it is conveyed to the user site by means of the gas pipeline.

14. The method of claim 10, wherein the gaseous oxygen is produced in step a) by a VSA or PSA adsorption unit.

15. The method of claim 10 wherein that the purity threshold value (VPS) is at least 70% by volume.

16. The method of claim 10 wherein the oxygen is produced in step a) by separation of air by adsorption of nitrogen on at least one adsorbent which adsorbs nitrogen preferentially to oxygen.

17. The method of claim 10 wherein the oxygen production flow rate is adjusted in step d) by acting on an opening of a recirculation valve situated on a bypass line formed on the gas pipeline carrying the produced oxygen, said bypass line configured to bypass at least one gas compressor situated on said gas pipeline, downstream of the adsorption unit, and furthermore serving to recycle, upstream of said at least one compressor, oxygen collected downstream of said compressor.

18. The method of claim 10 wherein
the production flow rate (Dp) is between 100 and 6000 Nm³/h;
the user flow rate (Du) is between 100 and 10 000 Nm³/h;
the purity (Pp) of the oxygen is between 88 and 95%; and
the user oxygen purity (Pu) is between 88 and 100%.
